(19) United States
(12) Patent Application Publication
(10) Pub. No.: US 2009/0125668 A1
(43) Pub. Date: May 14, 2009

(54) Management of erased blocks in flash memories

(75) Inventor: Reinhard Huhne, Reichenau (DE)

Correspondence Address: BROWDY AND NEIMARK, P.L.L.C.;624 NINTH STREET, NW, SUITE 300, WASHINGTON, DC, 20001-5303, US

(73) Assignee: Hyperstone AG, Konstanz (DE)

(21) Appl. No.: 10/571,590

(22) PCT Filed: Aug. 12, 2004
(86) PCT No.: PCT/EP04/51782

§ 371 Date: Jul. 14, 2008

(30) Foreign Application Priority Data
Sep. 10, 2003 (DE) 10341618.8

(51) Int. Cl. G06F 12/02; G06F 12/00

(52) U.S. Cl. 711/103; 711/166; 711/E12.001; 711/E12.008

(57) ABSTRACT

The invention relates to a method for managing the erasure process in a memory system comprising individually erasable memory blocks (SB) that can be addressed with the aid of real memory block addresses (SBA). Said memory blocks are sub-divided into a plurality of writable sectors and can be addressed by means of an address conversion that uses an allocator table (ZT) to convert logical block addresses (LBA) into one of the respective memory block addresses (SBA). According to the invention, the allocator table (ZT) is sub-divided into at least one useful data area (NB) and a buffer block area (BB). The invention is characterised in that a first identifier erased (ER), indicating the physical erasure status and a second identifier content erased (CER), indicating the logical erasure status, is set for each memory block (SB) in the allocator table (ZT).

The invention relates to a method to manage the erasure process in a memory system comprising individually erasable memory blocks that can be addressed with the aid of real memory block addresses. Said memory blocks are divided in a plurality of writable memory sectors that use an allocator table to convert logical block addresses into one of the respective memory block addresses.

Flash memories are used in many computer systems, in particular in changeable memory cards for digital cameras and portable computers. Flash memories are organised in memory blocks, each with a lot of sectors. The limited number of write and erase operations and the erasure of only large memory blocks are essential features of these memories and that writing operations are only possible in sectors, which are previously erased. Thereby the write and erase operations need much more time (up to a factor of 50) as the read operation. To achieve a high lifetime and a quick reaction of the memory system, it is important to work only with a few erase operations and to do the erase operations in times, when no write or read operations are pending.

In the patent application DE 198 40 389 is described, how by using dedicated buffer blocks sectors can be written without having to erase the whole memory block previously. If there are no more buffer blocks available, one of them has to be erased immediately, what delays the write operation.

In the U.S. Pat. No. 5,485,595 the management of memory blocks in a management table is described, which contains several flags for the status of the memory blocks. Among them are the flags “USED FLAG” and “OLD FLAG”, which indicate whether several versions of the memory blocks are present in the memory. The memory blocks with the “OLD FLAG” are pending for erasure. With each memory operation the management table is to be scanned for the valid entry to the logical block address, which extends the memory operations.

It is the task of the invention to optimize further the method for the erasure of memory blocks as described in the mentioned German patent application, further to get along with still fewer erase operations and to shorten the response times when doing write operations to sectors.

This task is solved by the fact that to each memory area in the allocation table a first flag “erased” is registered for the physical erasure condition and a second flag “content erased” for the logical erasure condition.

Favourable embodiments of the invention are indicated in the dependent claims.

The considered memory system with non volatile memory cells is organised in memory blocks, which are individually erasable with an erasure operation.

The memory blocks again are divided into sectors, which are individually erasable. Thereby the write operations are only possible into before erased memory cells. In an allocator table all memory blocks are listed. The allocator table is arranged into a first range for useful data blocks, a second range for administrative blocks, a third range for buffer blocks and a fourth range for reserve blocks. In the table there are pointers with memory block addresses and flags to the respective memory blocks, to which the pointers point. The allocator table is accessed by a memory controller with logical block addresses and each logical block address is assigned a real memory block address. In that real memory block assigned by the logical block address by means of the pointer the respective memory operation is accomplished. A seek for the memory block is not necessary.

In the allocator table, which is stored in administrative blocks, also the flags are written according to the status of contents of the respective real memory blocks. Among them are the flags “erased” and “content erased”. The first flag “erased” indicates that the associated memory block is completely physically erased. The second flag “content erased” indicates that the contents of the block is not yet physically erased, the contents however is not valid any longer and the block is intended for erasure.

The first flag “erased” is set after each physical erasure of the associated memory block in the allocator table. The second flag “content erased” is set after each becoming invalid of all contents of the memory block. Thus the two flags indicate in each case the status of contents of the associated memory block.

The administration of the memory blocks and the execution of the memory operations are controlled by programs in a memory controller. Under the programs is a background program, which is run if no memory operations, like reading, writing or erasure are pending. The background program scans the allocator table for memory block addresses with set second flag “content erased”. It erases so found memory blocks, whereby the first flag is set to “erased”.

If into a sector of a memory block is to be written, which is no more erased, it is favourable to look first for a erased memory block in the buffer block range into which new contents of the sectors is written Such a memory block is thus used as alternate block.

If no erased memory block in the buffer block area is found, it is favourable to look for a erased memory block in the useful data block area and to use such as alternate block.

Therefor the pointers on the erased memory block in the useful data block area and the pointer on a not erased block in the buffer block area are exchanged and now the not erased memory block in the useful data block area gets the characteristic “content erased”.

Since the useful data block area can be large and strongly occupied, it can last for a long time, until an erased memory block is found. Therefore it is meaningful if there is a number of erased memory blocks in the useful data block area of less than a predetermined threshold value, not to search the useful data area block for an erased memory block, but to erase a memory block in the buffer block area and to use this then than alternate block.

An alternate block found in the before-described kind is written completely with new sectors. Afterwards the entry of the real memory address belonging to the logical block address is exchanged with the address of the alternate block, and the past memory block is marked by the second flag “content erased”.

With the programs in the memory controller an access to arbitrary memory blocks and sectors is possible. By setting the flag to “contents erased” to a memory block, the contents shall be considered as erased, even if the memory cells still contain another contents. If now such a memory block is accessed by reading, a program in the memory controller recognizes this and returns data, which correspond to erased data.

A favourable embodiment of the invention is described exemplarily in the figures.

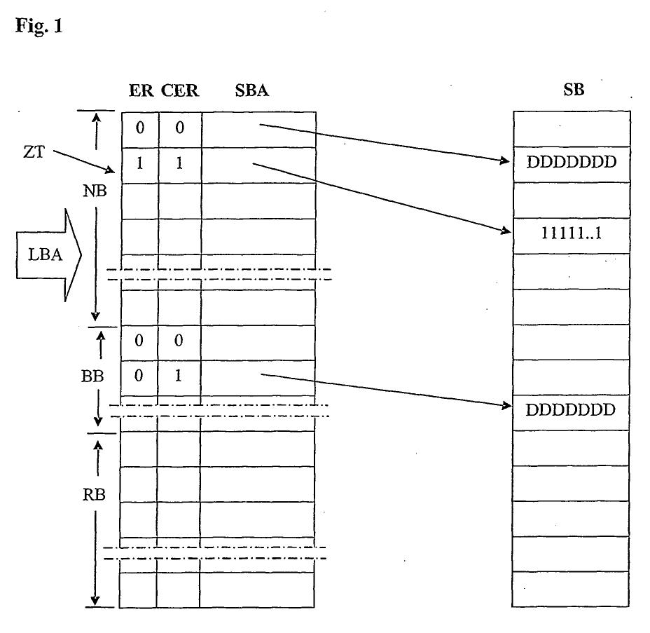

FIG. 1 shows the relation of the allocator table with the memory areas

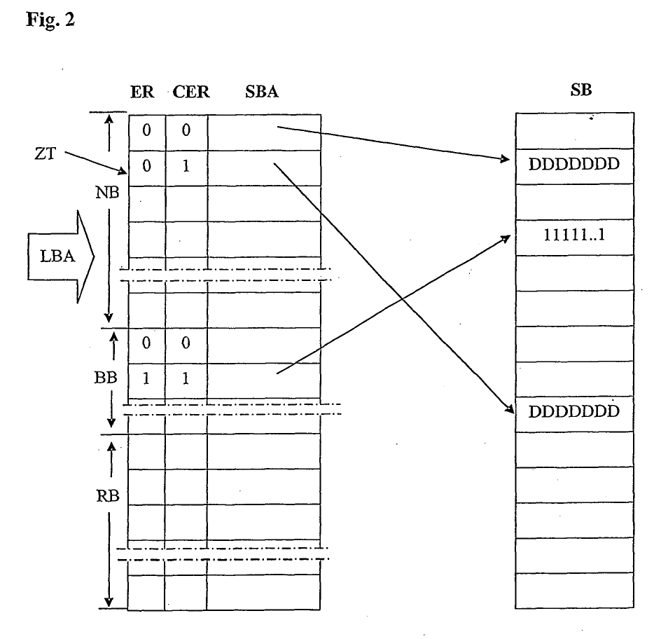

FIG. 2 shows the relation after use of a new useful data block,

In FIG. 1 is represented the allocator table ZT, which is arranged into three ranges. These are the useful data area NB, the buffer block range BB and the reserve range RB. The allocator table ZT is accessed by the logical block address LBA and one finds the associated memory block address SBA, which points to a memory block SB. To the memory block addresses SBA the flags “erased” IT and “content erased” CER are written.

The first entry of the allocator table ZT designates a memory block SB used with data. D. Here are the flags “erased” IT and “content erased” CER not set. The second entry designates erased memory block (111..1), with which the flags are set. In the buffer block range BB no erased entry with the flag “erased” set is present.

If now an alternate block is needed for a writing operation of a useful data block and no free buffer block is present, in the useful data block NB a block is looked for, whose flag is set “erased” ER. Here the second entry in the allocator table ZT is found. Now the two entries in the allocator table are exchanged.

In FIG. 2 the condition of the allocator table ZT is shown after exchanging the entries. The second entry points now to a memory block, whose contents is logically erased, which contains however still the old data D. This is characterized by the flag combination 01. The entry of the buffer block points now to the deleted memory block (111..1). This is used now as alternate block for the writing operation of the new useful data. The background program will later erase the memory block SB belonging now to the second entry.

1. Method for the management of the erasure in a memory system with individually erasable memory blocks (SB), addressable with real memory block addresses (SBA), which are divided into a plurality of writable sectors, and which are addressable by an address conversion by means of a allocator table (ZT) of logical block addresses (LBA) into a respective real memory block addresses (SBA), whereby the allocator table (ZT) is divided into a useful data range (NB) and into a buffer block range (BB), wherein, to each memory block (SB) in the allocator table (ZT), a first flag “erased” (ER) to the physical erase condition and a second flag “content erased” (CER) to the logical erase condition is recorded.

2. Method according to claim 1, wherein the first flag (ER) is set after each physical erasure of the associated memory block (SB).

3. Method according to claim 1, wherein the second flag (CER) is set when all the contents of the memory block (SB) become invalid.

4. Method according to claim 1, wherein the memory system is administered by programs in a memory controller.

5. Method according to claim 4, wherein a background program in the memory controller scans the allocator table (ZT) for memory block addresses (SBA) with set second flag (CER) and erase so found memory block (SB), whereby the first flag (ER) is set.

6. Method according to claim 4, wherein during renewed writing of not erased sectors of a memory block (SB) at first an erased memory block in the buffer block range (BB) is searched and this is used as an alternate block, into which the new contents of the sectors is written.

7. Method according to claim 6, wherein if no erased memory block in the buffer block range (BB) is found, an erased block from the useful data block range (NB) is used as alternate block.

8. Method according to claim 7, wherein if only less than a predetermined number of erased memory blocks in the useful data area is available, a memory block in the buffer block range (BB) first is erased and then is used as an alternate block.

9. Method according to claim 6, wherein after complete writing of the alternate block (AB) in the allocator table (ZT) the entry of the real memory address (SBA) is exchanged with the address of the alternate block and the past memory block (SB) is marked by the second flag (CER).

10. Method according to claim 9, wherein during the reading of a memory block with set second flag (CER) the memory controller returns erased data (111..1).
